(19) United States
(12) Patent Application Publication
(10) Pub. No.: US 2020/0389299 A1
(43) Pub. Date: Dec. 10, 2020

(54) QUANTUM SECURITY SYSTEMS

(71) Applicants: Cambridge Enterprise Limited, Cambridge (GB); UNIVERSITY OF YORK, York Yorkshire (GB)

(72) Inventors: Ian White, Cambridgeshire (GB); Yupeng Gong, Cambridgeshire (GB); Ricgard Penty, Cambridgeshire (GB); Adrian Wonfor, Cambridgeshire (GB); Rupesh Kumar, Cambridgeshire (GB)

(21) Appl. No.: 16/768,495

(22) PCT Filed: Nov. 30, 2018
(86) PCT No.: PCT/GB2018/053476

§ 371 Date: May 29, 2020

(30) Foreign Application Priority Data
Dec. 1, 2017 (GB) 1820063.5

(51) Int. Cl. H04L 9/08; H04B 10/85; H04J 14/02

(52) U.S. Cl. CPC H04L 9/0852; H04J 14/0227; H04B 10/85

(57) ABSTRACT

A method of detecting eavesdropping, i.e. a physical layer attack, on an optical communications channel. The method comprises sending a first, classical message over an optical channel by encoding the message onto an optical carrier using a classical communications technique and sending a second, quantum message over the optical channel using a quantum cryptographic technique, e.g. a Continuous Variable Quantum Key Distribution (CV-QCD) technique; and detecting eavesdropping of the classical message on the optical channel by detecting the eavesdropping of the quantum message. In implementations the classical and quantum signals may be substantially indistinguishable to hinder an adversary from eavesdropping on the first signal without influence the second signal.

### FIELD

This specification relates to systems and methods for increasing the security of optical communications, in some implementations using Continuous Variable Quantum Key Distribution (CV-QKD) techniques.

### BACKGROUND

In recent years, optical fibre network technology has seen rapid advances owing to the need to meet increasingly high data-rate communication demands. Currently, vulnerabilities in the security of optical fiber links are mitigated by using classical cryptographic schemes. However, recent research in quantum computing raises the risk of breaking current cyphers. Physical layer attacks in optical networks may be broadly categorized as either eavesdropping attacks or jamming attacks. The jamming attack is the process whereby a separate signal is injected to degrade the quality of the transmitted optical signal and disrupt the service. The eavesdropping attack involves the attacker utilizing techniques to tap off a part of the transmitted signal and gain information. One of the most well-known attacks of this kind is called fibre bending attack. In practice, attackers can combine the two approaches—eavesdropping and jamming, and is known as a correlated jamming attack. This attack is particularly critical as the attacker can tap a part of the optical signal, compensate the reduction in signal power with proper amplification. Lately, due to advances in quantum key distribution research, there has been concern about a type of harmful attack known as the intercept and resend attack. A detailed introduction to the physical layer attacks in optical communication systems is published by M. Furdek, in “Physical-layer attacks in optical WDM networks and attackaware network planning” in European Journal of Operational Research (vol. 178, no. 2, pp. 1160-1167, 2011).

Currently, several fibre surveillance and monitoring methods exist which aim to prevent the current physical layer attacks. Some require an additional pilot signal or monitoring signal, while others require customized fibre, e.g. optical cables with fibres surrounding them (U.S. Pat. No. 6,801,700), or fibres with electrical conductors. To date, the most widely adopted methods are based on monitoring the power of the optical signal, e.g. Modes' Power Monitoring, optical mean power measuring (All Optical Networks (AON), National Communication System, NCS TIB 00-7, August 2000), and OTDRs. However, as explained before, it is possible to maintain the link power while splitting part of the information with a correlated jamming attack.

In the case of the power monitoring method to detect attacks, e.g. U.S. Pat. No. 6,819,849, the accuracy is normally worse than 0.5 dB when detecting the eavesdropping attack.

Moreover, its performance is communication protocol dependent. The jamming attack is detectable with this method, because the attack will increase the average power at the optical monitor. However, the sporadic nature of the attack may not cause the required resulting statistical anomalies to be detected quickly. In addition, this method will not detect the correlated jamming attack as the total power will remain unchanged.

In the case of the optical spectral analysis method (OSA) to detect attacks, e.g. EP1211827A, a problem exists as it will not be able to detect eavesdropping on the channel that is tapped unless the eavesdropping leads to a disruption of the tapped signal spectrum. An OSA will only detect jamming attacks that significantly affect the received optical spectrum.

In the case of the pilot tone method, e.g. US2014/0072296, a sophisticated attacker can filter out the pilot signal when attacking the channel. For example, pilot tones will not be effective in detecting jamming attacks unless those attacks cover the wavelengths at which the pilot tones are carried.

In the case of the OTDR method, e.g. U.S. Pat. No. 5,093,568, the major advantage is that it can detect the location of the fault position. However, its accuracy of detecting power changes is low. In addition, as in the case of the pilot tone method, the attacker can filter out the reflected signal. Moreover, it has a long reaction time and cannot characterize the fault.

None of the current methods can detect an intercept and resend attack. More generally, despite the commercialization of current monitoring techniques, their limitations in respect of sophisticated physical layer attacks are significant.

Qi, Bing, “Simultaneous Classical Communication And Quantum Key Distribution Using Continuous Variables” in Physical Review A 94.4 (2016), describes technique in which bits for classical communication and Gaussian distributed random numbers for GMCS (Gaussian-modulated coherent states) QKD (quantum key distribution) are encoded on the same weak coherent pulse. Further background can be found in “Displacement Operator By Beam Splitter Physics Letters A 217.2-3 (1996), 78-80, M. G. A. Paris. Further background prior art can be found in WO2017/196545 (US2017/0331623); EP3301851; US2007/0212063; and GB2514134A.

### SUMMARY

This specification describes a method of detecting eavesdropping on an optical communications channel such as one or more optical fibres. The method comprises sending a first, classical message over an optical channel by encoding the message onto an optical carrier using a classical (non-quantum) communications technique and sending a second signal over the same optical channel using a quantum cryptographic technique. The method further involves detecting eavesdropping of the classical message on the optical channel by detecting the eavesdropping of the second signal. Here eavesdropping includes e.g. a fibre tapping attack but may also include a jamming attack.

Thus because the classical message and second, quantum signal are sent over the same channel it is difficult to eavesdrop on the classical message without affecting the second, quantum signal in a detectable manner. The method can be used against a range of attacks including, for example, an intercept- and resend attack. Some advantages of the method over other approaches may include simplified system design, for example as compared with a technique in which a key is decoded from the quantum signal; reduced cost, and increased distance communication.

The classical communications technique may employ any of a wide range of optical signal modulation techniques, typically a digital modulation scheme involving phase and/or amplitude modulation of one or more carriers.

In some implementations the second signal is sent, for example on the same optical carrier, using a continuous variable quantum key distribution (CV-QKD) technique. This can simplify the receiver design and may facilitate communication over longer distances. Thus the second signal may be sent using a so-celled “weak coherent pulse” or “weak coherent signal”. Thus in this specification a CV-QKD signal/technique may be a quantum cryptographic signal/technique in which a so-called weak coherent state is modulated at the quantum level.

A continuous variable QKD technique may be used to encode signal values as one or more continuous variables, for example amplitude and/or phase (quadrature); thus a CV-QKD technique may be used to encode binary signal values or signal values taking one of n states as well as continuous signal values. In principle a single photon DV (Discrete Variable) QKD technique could be employed for the quantum cryptographic technique but this would not permit the quantum and classical signals to be made indistinguishable.

In some implementations the classical message and the second signal are sent at the same wavelength for increased security, in particular to resist an attack in which one wavelength is split off. In a wavelength division multiplexed optical communications system each wavelength may be provided with a corresponding second signal.

The classical and quantum communications signals, that is the classical messages and second signals, may be time-interleaved in a time-division multiplexed system. The time slots for the second, quantum signals may be selected randomly, which here includes quasi-randomly, for increased security.

At the receiver the time slots with the second, quantum signals may be distinguished by detecting characteristics of the classical messages, for example by detecting a pattern within the optical signal; if no pattern can be detected the time slot may be identified as carrying a second, quantum signal. For example the system may attempt to decode data from a time slot based upon the modulation scheme of the classical messages. The method may thus further include delaying the time-division multiplexed optical signal to compensate for the time taken for decoding or pattern detection, and identifying a second signal in the delayed messages by an inability to decode data from a time slot. For example the system may set a flag identifying quantum packets.

Different detectors may be used for the classical and quantum optical signal receiver systems. For example the classical signal detector may have a higher bandwidth than the quantum signal detector. Typically the classical signal detector is a high bandwidth detector for detecting and demodulating high bandwidth classical signals carried on the optical channel. Typically the quantum signal detector is a low bandwidth, low noise detector with high sensitivity. When a second, quantum signal is identified this may be routed to and/or read from the quantum signal detector following identification of the presence of this signal. Thus at the receiver an input optical signal may be split into a portion for the classical signal detector and a second portion which is routed via an optical delay such as a fibre optic to the quantum signal detector.

In some implementations an optical power level of the classical message and second signal are matched in the optical channel, for example fibre optic, so as to make these two signal components difficult to distinguish for an eavesdropper. In this case, because the quantum signal detector is typically more sensitive than the classical signal detector at the receiver a fraction of the received optical signal may be split off and directed to the quantum signal detector. The fraction may be less than 50%, 10%, or 5%, for example around 1%.

Thus in some implementations of the method/system the classical and quantum signals may be substantially indistinguishable in terms of their intensity and wavelength; moreover an eavesdropper may not be able to attack the classical signal without influencing the quantum signal.

In some implementations detecting eavesdropping of the second signal using a quantum cryptographic technique may comprise accounting for end-to-end noise in sending and receiving the second signal, including accounting for vacuum noise. Here vacuum noise is quantum noise associated with the vacuum state; it may sometimes be referred to as shot noise (which is different to the shot noise encountered in electronic circuits). Because noise at the quantum level is accounted for it is possible to detect eavesdropping as an increase in noise level, that is as an unaccounted for noise component when receiving the second signal.

In some particular implementations accounting for the noise in sending and receiving the second signal may include obtaining a value for a noise variance of the transmitted signal, for example by receiving a transmitted message noise variance sent from a transmitter of the second signal. The noise variance at the receiver of the second signal may be measured or estimated. These values together may be employed to determine a transmittance for the optical channel. An intrinsic noise value for the detector may be determined from the detector with no optical input; this may be stored during calibration and retrieved when needed. Knowing these noise levels enables the vacuum noise level to be determined. Thus if an increased noise level is present at the detector after accounting for all these noise components an eavesdropping attack can be assumed.

These values may, but need not assume Gaussian continuous variables for the encoded data. Continuous rather than n-state variables may be encoded to facilitate making a variance measurement multiple times, hence increasing security.

At the transmitter data may be encoded into in-phase (X) and quadrature (P) components of the second, quantum signal. These may be decoded using homodyne detection, with a local oscillator signal which may be generated at the transmitter and provided to the receiver or which may be generated locally at the receiver. The latter approach may, for example, use a local local oscillator (LLO) technique and another laser at the receiver. The local oscillator power may approximately match that of the second signal where the signals are mixed. The transmitted data may comprise random data and/or encoded information to be transmitted. Data may, but need not be, decoded from the second, quantum signal. For example, there is no need for a key to be decoded from the second signal.

In another aspect there is described a method for detecting an eavesdropper on an optical communication channel, the method comprising: sending a first signal using a classical communication technique and a second signal using a quantum cryptographic technique, over the optical communication channel; obtaining noise of the second signal and transmittance for the second signal; and detecting an eavesdropper on the first signal if one or both of the noise and the transmittance of the second signal change by greater than a threshold value.

In some implementations the first signal and the second signal are sent using a time division multiplexing technique. The first signal and the second signal may be sent in random time slots, and may be substantially equal in intensity. In some other implementations the first signal and second signals may be sent simultaneously on a single optical pulse.

There is also described a method of transmitting an eavesdropping-protected signal over an optical communications channel, in particular as previously described, comprising: sending, preferably time-domain multiplexed over the same optical channel and at the same wavelength, a classical message using a classical communications technique and a second signal using a quantum cryptographic technique.

The previously described techniques may be employed with the method, thus the second signals may be randomly allocated to time slots of the time-domain multiplexing.

There is also described a method of receiving an eavesdropping-protected signal over an optical communications channel, in particular as previously described, comprising: receiving, over the same optical channel and at the same wavelength, a classical message sent using a classical communications technique and a second signal sent using a quantum cryptographic technique; and detecting eavesdropping of the classical message on the optical channel by detecting the eavesdropping of the second signal.

There is also described a transmitter, and a receiver configured to implement these methods.

Thus the transmitter may comprise a coherent light source to provide an optical carrier and one or more modulators to encode the classical and second signals onto the optical carrier.

The receiver may comprise one or more detectors, and a signal processor, to detect and demodulate the classical message and to detect and identify eavesdropping of the second signal.

There is also described a system for detecting eavesdropping on an optical communications channel, the system comprising: a transmitter configured to send over the same optical channel and at the same wavelength, a classical message using a classical communications technique a second signal using a quantum cryptographic technique; and a receiver configured to receive the classical message and the second signal, and to detect eavesdropping of the classical message on the optical channel by detecting the eavesdropping of the second signal.

In some embodiments the technique can detect an eavesdropping attack by measuring the real-time transmittance of the channel with high precision. Unlike the conventional power detection method the technique may have has adjustable measurement precision. By choosing parameters such as estimation block (sample) length; quantum signal modulation variance V_{A}; and estimation confidence level, the accuracy can be better than 0.01 dB at a transmission distance up to 100 km. Because the eavesdropping detection uses the quantum signal the technique may be independent of the classical signal modulation format. In addition the quantum signal may be indistinguishable from the classical signal, and may carry information if desired e.g. to distribute quantum keys.

Potentially any channel jamming attack that degrades the classical signal performance can be detected by the quantum signal. This is because the signals, modulated at the quantum level, are vulnerable to any unauthorized measurement in or interference with the channel which introduces noise. In addition the technique can be very sensitive to the channel loss. Both the signal noise and transmittance can be estimated by post-processing the quantum signals, whereby the receiver compares the values with those from the transmitter. Thus examples of the technique can also detect an intercept and resend attack that only introduces noise on the quantum signal, not on the classical signal.

Thus, by monitoring the excess noise and the channel transmittance, the quantum alarm can characterize a channel fault. In addition, one can also use quantum signals for secure key generation that can further be used to encrypt the transmission channel Hence, the system/method can provide multi-layer security of the link (quantum encryption and real-time monitoring) if required. As the quantum signals and classical signals can be generated using similar equipment and have similar forms, the system/method can transmit quantum signals and high-speed normal communication signals simultaneously through the protected link.

In some implementations of the above described techniques optical amplifiers may be employed in the optical link to increase the transmission distance of the quantum alarm system beyond that of an unamplified system. In this case the noise performance of the optical amplifiers may be characterized so that this can also be accounted for when detecting the second, quantum signal, to optimise the sensitivity of detection of the second, quantum signal.

In some implementations of the above described techniques the second signal may also carry classical information. For example the second and first signal may be sent in the same optical pulse or optical mode.

In some implementations of the above described techniques the second signal may be multiplexed using any multiplexing technique, e.g. WDM (Wavelength Division Multiplexing).

### BRIEF DESCRIPTION OF THE DRAWINGS

These and other aspects of the invention will now be further described by way of example only, with reference to the accompanying Figures, in which:

FIG. 1 shows example quantum alarm monitoring system apparatus.

FIG. 2 shows an example monitoring system flow chart.

FIG. 3 is an illustration, in phase space, of a displaced coherent state modulated at the quantum level.

FIG. 4 shows a block diagram of an example transmitter for the system of FIG. 1.

FIG. 5 shows simulated monitoring performance results.

FIGS. 6a to 6c show, respectively, an experimental result from the QA monitoring system of FIG. 1, accuracy of the experimental transmission monitoring, and accuracy of the experimental quantum excess noise monitoring.

### DETAILED DESCRIPTION OF PREFERRED EMBODIMENTS

System and methods are described that can monitor the security of a high-speed classical optical communication system using quantum technology. More particularly a real-time, protocol-independent, quantum alarm (QA) system is described that can be integrated directly within a high-speed classical communication system. It utilizes a signal whose quantum coherent state is modulated, with time division multiplexing being used so that the quantum alarm and classical communication system can operate over the same link at the same wavelength.

In implementations the quantum signals are offset in intensity so that their intensity is indistinguishable from the classical signals, making it difficult to distinguish to quantum and classical signals. This offset may be used to send classical information.

The system can also, if required, provide multilevel security (high precision real-time monitoring and quantum encryption) by utilizing quantum technologies and an advanced security monitoring method compatible in form with the post processing used in CVQKD systems. Examples of the QA system are potentially able to detect all classes of known physical layer attacks targeting high-speed classical communications and to monitor link security with extremely high precision.

In broad terms the described techniques aim to use coherent states which are modulated at the quantum level. In quantum mechanics, a coherent state is a quantum state with minimal uncertainty in both quadratures in the phase space. Continuous variable quantum key distribution (CVQKD) is a secure key distribution technology that utilizes the quantum coherent state, more particularly a coherent state modulated at the quantum level. A number of modulation protocols have been proposed to modulate the coherent state intensity to encode information. For example, in the Gaussian modulated coherent states protocol, Alice prepares the coherent state with a quadrature modulation variance V_{A} and sends to Bob through the quantum channel. Bob measures the quadrature with a shot noise limited (quantum sensitive) coherent receiver. Alice and Bob identify the presence of eavesdropper through the estimation of channel transmission T and excess noise ξ. The techniques described herein can employ a variant on the estimation method to monitor channel security.

One aim is to monitor the security of classical high-speed communication using quantum signals. Thus some implementations use a modulation scheme that combines high-speed classical signals with quantum signals (114). The system utilizes optical time division multiplexing (TDM (102)) to integrate quantum signal with the classical signal. The quantum signal has offset in its intensity to make it indistinguishable from the classical signal (107). The quantum signal (114) and classical signal (107) are sent in random time slots. The invention comprises a quantum signal transmitter (100), a shot noise limited (quantum sensitive) low bandwidth quantum receiver (103) and includes one classical optical transmitter (101) and receiver (104), time-division-multiplexing modules (102), an optical beam splitter at the receiver side (202) and an optical channel (111). In addition, the invention incorporates quantum security monitoring modules (105) to monitor the excess noise and transmittance. The quantum signal and classical signal shares the same optical link.

Preferably, the slot duration is in the range 10 ns-10 us, and is determined by the bandwidth of shot-noise limited homodyne detector. Preferably, the choice of quantum signal's modulation scheme can be defined according the user's requirements. Preferably, the quantum signal are offset in its intensity to match the intensity of classical signal. Preferably, the quantum signal and classical signal are send at the same wavelength in the same channel. Preferably, an attenuator is used before the quantum receiver to decrease the quantum signal intensity to avoid detector saturation. Preferably, the quantum security monitoring (105) block (sample) size should be adjusted with respect to the quantum signal repetition rate to ensure real-time monitoring with sufficient precision. Preferably, the quantum signal can be used to monitor the channel physical layer security and also secure key distribution if required. Preferably, the classical communication signal are received near the receiver sensitivity to have maximum transmission distance.

Another aspect of the system comprises the software control for the data post-processing which includes security monitoring (105), quantum signal post-processing (108) and classical data demodulation (106). The user monitors the real-time results from the security monitoring module to trigger the fault alarm when it detects physical layer attack (109). The excess noise and transmittance parameters are continuously estimated during the process. If the channel is secure, the quantum post-processing is able to process the quantum data to distil the quantum keys if required.

In more detail, as previously described the monitoring system may employ the uncertainty relationship of the coherent state quadratures to detect attacks. The signals, modulated at the quantum level, are vulnerable to any unauthorized measurement in the channel, which introduces noise. In addition, they are very sensitive to the channel loss. Both the signal noise and transmittance can be estimated by post-processing the quantum signals in which the receiver compares the values with those from the transmitter. The post-processing may be similar to the parameter estimation used in continuous variable quantum key distribution (CVQKD), but without the need for data reconciliation for key generation. In the present alarm system, the parameters are instead used to monitor eavesdropping on the classical signals. The alarm monitors the changes in transmission, T, and excess noise, ξ, with very high precision; this can be optimized by choosing appropriate block size of the quantum signal data.

As previously described one aim of the invention is to monitor physical layer attacks targeting the high-speed classical communication system using quantum technology.

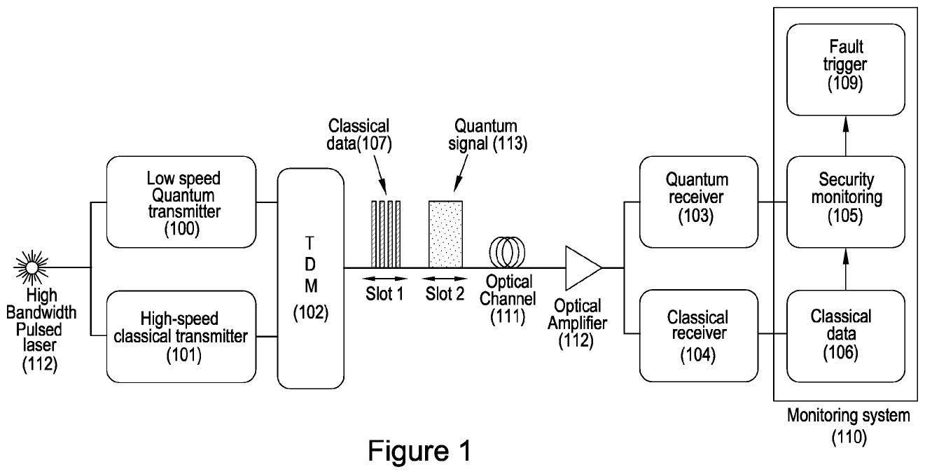

As shown in FIG. 1, the system can be integrated into any conventional optical communication system directly. It is based on the integration of a classical optical communication system and a quantum communication system. The hardware of the system comprises a quantum signal transmitter (100), quantum signal receiver (103), classical transmitter (101), classical receiver (104) and TDM (102) module to multiplex the two signals in random time slots. The quantum and classical signals share the same optical channel (111). The quantum transmitter (100) and receiver (103) typically comprises optical and electronic components adapted to produce and detect quantum states that contain continuous variables. For continuous variable quantum states, information is introduced by modulating the quadrature values of the coherent states. Homodyne detectors or heterodyne detectors are used for detecting quantum modulated coherent states at the quantum receiver. The quantum receiver also contains an attenuator to avoid the detector saturation. The quantum transmitter and receiver are controlled by microprocessors or computers. The classical transmitter (101) and receiver (104) is high-bandwidth optical and electronic components to transmit high-speed classical communication signals at data rates up to hundred Gbits per second or more. The quantum signal and classical signal are modulated onto the optical signal from the same laser (112) to ensure their carrier signals are at the same wavelength. The TDM (102) multiplexer is typically made of optical switches, optical delays, and couplers. The TDM (102) multiplexer is controlled by one or more PCs or microprocessors to allocate random time slots for quantum and classical signals. The classical transmitters typically comprise optical and electronic components to generate high speed classical optical communication signals. The classical receiver typically comprises classical high-bandwidth photodetector and DSP modules.

In operation, the short optical pulse generated from the laser is split or switched into two branches. After the quantum signal (114) and classical signal (107) are modulated, they are multiplexed by the OTDM (102) multiplexer. At the receiver side, the OTDM (102) signal is directed into two branches, namely the quantum receiver (103) and classical receiver (104) respectively. The high bandwidth classical receiver (104) detects the ongoing signal and distinguishes the fast modulated classical signal (107) from the slow modulated quantum signal (114). When the classical detector (104) identifies the quantum signal slot, by searching the modulated data patterns, a feedback signal is sent to the quantum receiver controller and it will then process the quantum receiver output. Doing so makes the quantum post-processing (105) module store the measurement result to perform attack monitoring and preferably for the secure key generation purposes.

It is helpful if the quantum signal (114) and classical signal (107) are equally secure against physical layer attack. Hence some implementations of the system/method send both signals over the same channel (111) at the same wavelength. The system utilizes optical time division multiplexing whose typical slot duration is 10 ns-10 us. The slot duration is determined by the bandwidth of the quantum system, which is considerably lower than that of the classical system. The classical signal has much higher bandwidth to meet the high communication demand. As shown in FIG. 1, after modulation, the classical signal (107) has a much smaller pulse width compared to the quantum signal (114), which can only has one pulse in a time slot.

To make sure that attackers cannot filter out the quantum signal whilst avoiding detection, the quantum and classical signals are sent in random time slots. In addition, the low intensity of the quantum signal (114) is another vulnerability that an eavesdropper may make use of. Hence, in this system, the CVQKD signal (114) may be offset in magnitude to increase the intensity to the classical level. In the present system, the quantum transmitter (100) first generates the quantum modulated coherent states and then displaces (offset) them. After measurement, the quantum receiver evaluates the offset, and refines the information retrieved from the quantum signals by removing the offset.

The offset intensity of the quantum signal should preferably be adjusted carefully with respect to the system. For instance, if the bandwidth of the quantum detector is 100 MHz, a time slot of 10 ns may be used. In addition, the classical signal may be modulated at 10 Gb/s and received near the receiver sensitivity of −30 dBm. This means that more than 10⁵ photons are received per time slot, however this will saturate the quantum receiver. Some implementations of the system/method therefore preferably use a splitter which reduces the quantum signal by 20 dB (1000 photons per time slot).

The sensitivity of the quantum receiver is defined by the shot noise variance when measured with no signal input (shot noise limit). The amplitude of the quantum signal may be expressed in multiples of the units of shot noise variance (snu). The modulation variance of the quantum signals at the receiver is set to 100 snu to take account of system losses. In the previous case, the quantum signal variance is reduced to 1 snu after the attenuator. The estimation of excess noise and channel transmittance may be performed on a sample size of 10⁷ pulses leading to a statistical precision of 0.0003 on the estimation of the offset. This more precisely measures the quantum signal variance, allowing better evaluation of the noise added by an eavesdropper. A detailed analysis of the parameter estimation accuracy and precision can be found in “Finite-Size Analysis Of A Continuous-Variable Quantum Key Distribution” in Physical Review A (2010) by Leverrier, Anthony, Frédéric Grosshans, and Philippe Grangier.

Unlike CVQKD post processing (108), where part of the quantum states are used for parameter estimation, all the quantum states can be used for channel security monitoring (105). This is because monitoring does not need to distil keys.

In addition optical amplifiers may be used to increase the transmission distance of the monitoring system whilst maintaining very high monitoring precision by accounting for the amplifier noise precisely and choosing an appropriate quantum signal block length. However the quantum communications channel is very sensitive to the channel excess noise and this could hinder the ability to send secure quantum signals over the channel were that desired.

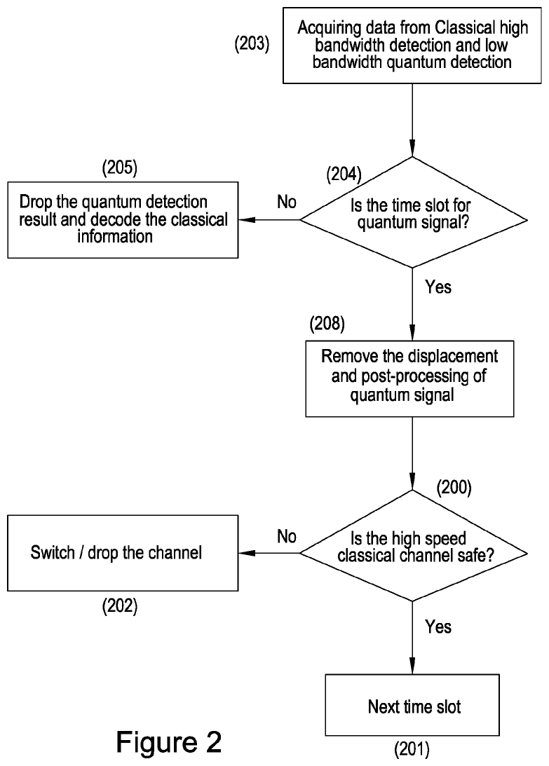

As shown in FIG. 2, the alarm control system follows the flow chart. The control system acquires the measuring results from both the quantum detector and classical detector (203). It then determines from the classical detection (204) whether this time slot is for the classical signal (107) or for the quantum signal (114).

If the time slot is for the classical signal, the control system drops the data acquired from the quantum receiver (207). In addition, the results from classical receiver will be demodulated as usual in the classical optical communication system (206) with the DSP modules. The variables encoded in the quantum signals will also be sent via classical communications in the adjacent time slot.

If the time slot is for the quantum signal, the control system post processes (208) the results measured by the quantum transmitter to monitor the security of the channel. If the monitoring result indicates a possible physical layer attack, the control system switches or drops (201) the channel before the next time slot The security of the channel is evaluated by the two parameters introduced previously. One can characterize the attack by different thresholds. For example, a sudden change of the transmittance indicates an eavesdropping attack.

The quantum signal can be sent using other methods, for example WDM (wavelength division multiplexing). In addition, the offset of the quantum signal can also be used to transmit classical data, i.e. quantum classical hybrid communication. One can monitor the security of the classical data encoded in the offset using the same method.

The system can also be utilized for continuous variable quantum key distribution (108), if required, by modifying the post-processing methods.

### FURTHER DESCRIPTION

Thus in broad terms, in some implementations of the technique utilize coherent states which are modulated at the quantum level. In quantum mechanics, the coherent state may be a quantum state with minimal uncertainty in both quadratures in the phase space and may be used to encode quantum information. There are various modulation protocols to modulate the coherent state at quantum level for the purpose of continuous variable quantum key distribution (CVQKD), e.g. Gaussian modulation.

In some implementations a method for detecting a physical layer attack e.g. an eavesdropper on an optical communication channel may comprise sending a first signal using a classical communication technique and a second signal using a quantum cryptographic technique over the optical communication channel. The two signals may be indistinguishable in terms of intensity, wavelength and an eavesdropper cannot attack the first signal without influencing the second signal. The method may include obtaining noise and transmittance of the second signal. The method may include detecting a physical layer attack on the first signal if one or both of the noise and the transmittance of the second signal change of greater than a threshold value.

The second signal can also carry classical information. The first signal and the second signal may be sent using time division multiplexing and the second signal may thus be independent of the modulation of the first signal. The second signal is displaced in phase space and has the classical level of intensity. The two signals may be sent in random time slots to make them indistinguishable to an eavesdropper. The two signals may be sent on the same optical channel and wavelength. Some implementations of the technique are agnostic to the classical signal protocol used; thus the classical signal displacement may encode data according to, for example, BPSK (binary phase shift keying), QPSK (quadrature phase shift keying), and so forth. The technique may have adjustable measurement precision, for example by choosing parameters such as the quantum signal modulation variance (V_{A}), the estimation block (sample) length, and the estimation confidence level.

In some implementations, the quantum signal displacement may also carry classical information. Thus, the two signals can also be sent simultaneously e.g. on a single optical mode or multi-mode, where the outgoing signal is a displaced coherent state with both quantum and classical intensity or phase modulation. At the transmitter, the coherent state is first modulated at quantum level and then displaced to a classical intensity level. This is followed by classical modulation. The classical modulation can be at a much higher frequency e.g. an intensity modulation, or m-ary modulation techniques. Hence, one quantum bit may be sent with one or several classical bits.

At the receiver, the incoming signal may be directed to two separate detectors. A classical receiver system may identify the classical information encoded in classical modulation while a quantum receiver system may remove the displacement and detect the quantum information encoded on the carrier. An adversary is inhibited from eavesdropping on the classical signal without influencing the second signal, which in implementations is encoded on the same optical pulse.

Thus the method may further include encoding classical information encoded in the quantum signal displacement; the method may then include detecting the classical information encoded in the quantum signal displacement and optionally decoding quantum data encoded in the quantum modulation after removal of the displacement. Thus a receiver of the method/system may demodulate classical data encoded on a displacement of the quantum signal.

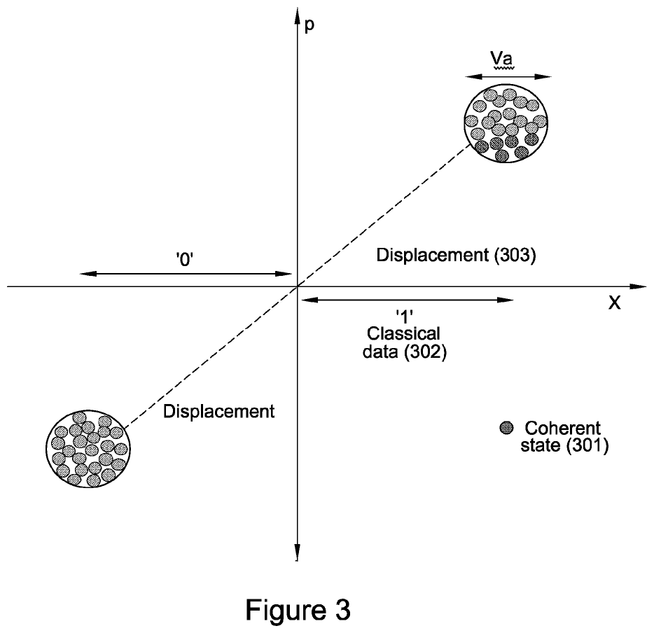

Thus referring now to FIG. 3, this shows an illustration, in phase space, of a displaced coherent state modulated at the quantum level. More particularly FIG. 3 shows an example of a coherent state (301) with BPSK classical modulation (302) and quantum gaussian modulation in phase space. The classical information is encoded in the phase information of the displacement (303). The Gaussian modulation has a variance of Va. Apart from BPSK modulation, other m-ary modulation techniques, e.g. QPSK, may be used to transmit one or multiple classical bits with one quantum bit. At the receiver, the quantum receiver identifies the classical information encoded in the displacement and then removes the displacement to decode the quantum data.

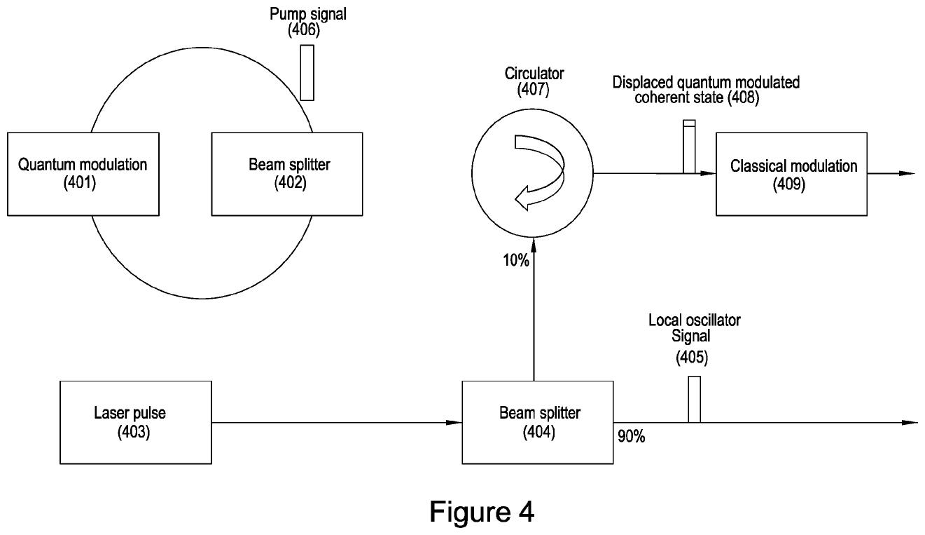

FIG. 4 shows a block diagram of an example transmitter for the system of FIG. 1. The quantum transmitter first modulates the coherent state at the quantum level (401) and then displaces it to a classical intensity level using pump light (406). A laser pulse (403) is first divided by an e.g. 90/10 beam splitter. The stronger pulse is used as a local oscillator (LO) signal (405) whilst the weaker pulse is fed into a Sagnac loop through a circulator (407). The Sagnac loop is implemented using a highly reflective beam splitter (402) which divides the pulse into pump (406) and signal pulses. One or more amplitude and phase modulators within a quantum modulation module (401) prepare Gaussian modulated coherent states from an anti-clockwise propagating signal pulse while also controlling the angle as well as an amount of displacement of the clockwise propagating pump pulse. The pump pulse (406) displaces the Gaussian modulated signal at the beam splitter (402). It is also possible to transmit the first and second signal simultaneously by modulating the displaced quantum modulated quantum signal (408) with classical modulation (409). Since the classical signal and quantum signal are sent through the same optical pulse, the two signals are essentially indistinguishable for an eavesdropper.

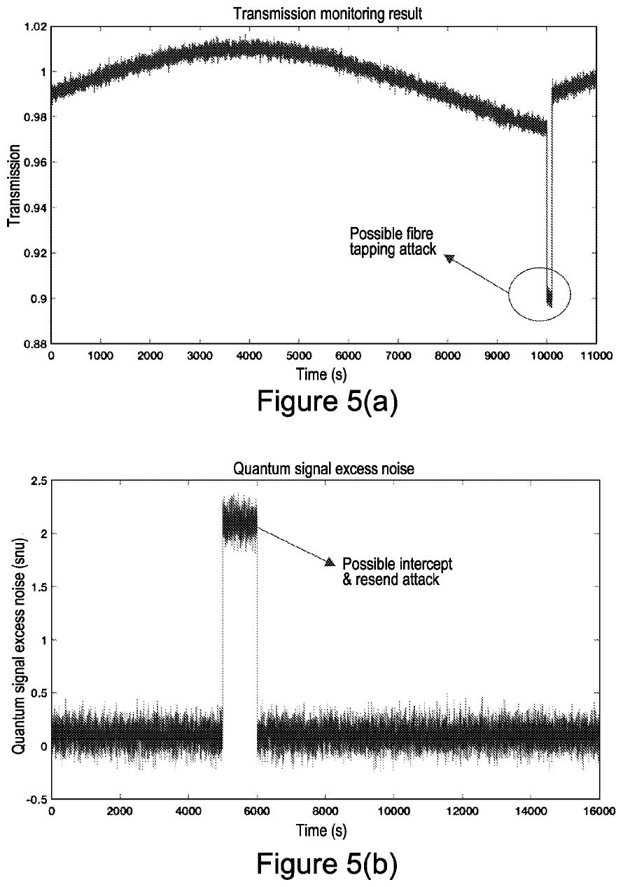

FIG. 5a shows a simulated example monitoring result illustrating a possible fibre tapping attack; FIG. 5b shows a simulated example monitoring result illustrating a possible intercept&resend attack. As can be seen from FIG. 5a, the monitoring performance is very sensitive, with a precision of better than 1%. Due to the laser source the light power in the channel may be fluctuating slowly. However, a sudden change of 1 dB can be easily detected by fast monitoring using the quantum signal. The possible attacks lasts for around 100 data points, which indicates that the attack lasts 10 seconds for a monitoring block length of 10⁷ and a repetition rate of 100 MHz. FIG. 5b illustrates the monitoring result of a possible intercept&resend attack. The monitoring accuracy is better than one snu (shot noise unit), i.e. one photon, which is very sensitive compared to classical methods. Furthermore an intercept&resend attack will increase the quantum signal excess noise by twice the shot noise unit.

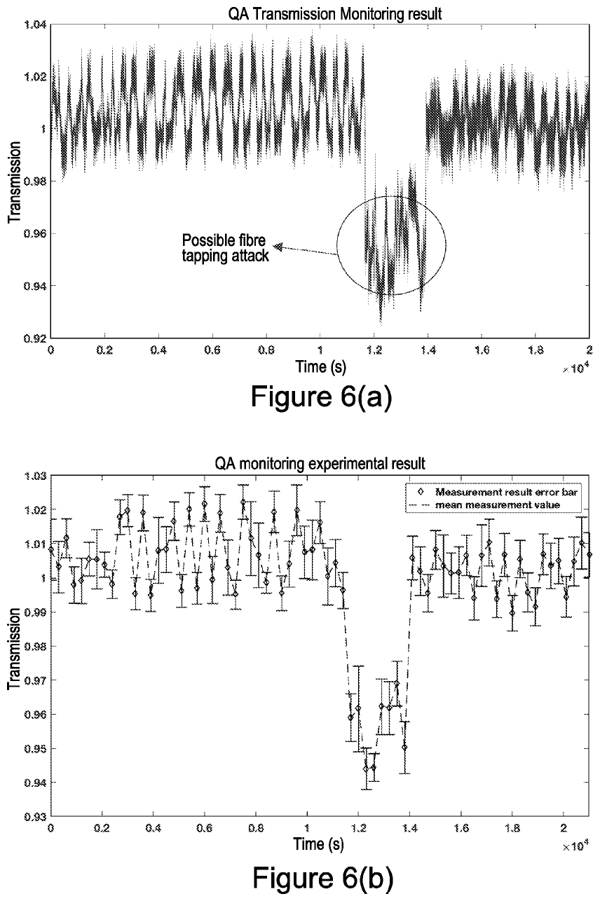

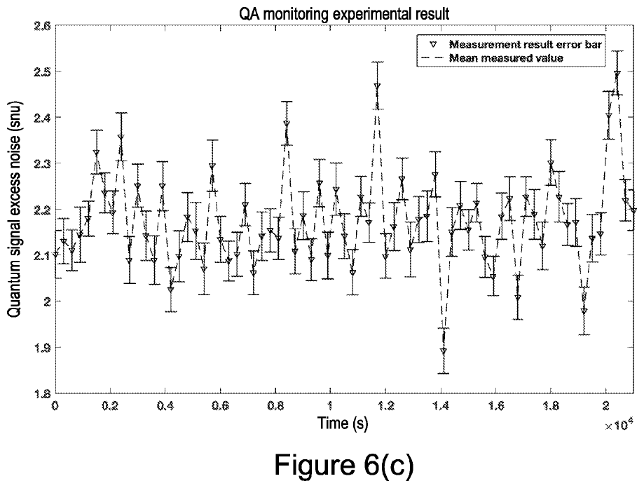

The results of prototype demonstration experiments are shown in FIG. 6. The results show that the QA (quantum alarm) system is able to monitor small changes in the channel, and detect a potential attack from abnormal changes in the monitoring waveform. FIG. 6b and FIG. 6c show that the experimental monitoring uncertainty and the transmission monitoring precision is better than 1% and that the quantum excess noise monitoring precision is better than 0.1 snu. The performance of this prototype system may be improved e.g. by reducing the laser power fluctuation.

There is also described a method of using an optical link amplifier to extend the transmission distance of both the first and second signals. This may maintain the monitoring precision by precise modelling of the amplifier noise and/or by choosing an appropriate block size for the quantum signal data. Such an optical amplifier can be used in the channel to extend the transmission distance to more than 200 km.

Thus, as previously described, it is possible to use one or more optical amplifiers (112 in FIG. 1) in the channel (111) to increase the transmission distance of the monitoring system whilst maintaining very high monitoring precision, in particular by accounting for the amplifier noise precisely and choosing an appropriate quantum signal data block size.

Normally, in continuous variable quantum key distribution (CVQKD), fibre amplifiers cannot be used to extend the transmission distance of the system as this destroys the quantum information stored in the quantum states and introduces noise. However in some implementations of the systems described herein no key is distributed (no secure quantum signal is sent) and thus in these implementations an optical amplifier can be used in the optical channel. QA (quantum alarm) system performance can be improved at longer distances by using an amplifier: Although an optical amplifier introduces additional noise to the quantum signal, the additional excess noise does not degrade the monitoring security because it is typically a sudden change in the excess noise that is being monitored, and an increase in the baseline signal noise does not affect this. The additional noise introduced by amplifier is treated as trusted noise and only influences the monitoring uncertainty. The modelling of noise introduced by amplifiers to quantum light states have been studied extensively; details can be found in “Improvement of continuous-variable quantum key distri-bution systems by using optical preamplifiers”, S. Fossier, E. Diamanti, T. Debuisschert, R. Tualle-Brouri, and P. Grangier in Journal of Physics B: Atomic, Molecular and Optical Physics, (vol. 42, no. 11, p. 114014, 2009). Example optical amplifiers which may be used in a system as described herein include: a phase insensitive amplifier (e.g. a degenerate parametric amplifier), a phase sensitive amplifier (e.g. a non-degenerate parametric amplifier, such as an Erbium-doped fiber amplifier), and a noiseless linear amplifier.

The described QA system is compatible with current optical transport network infrastructure, with both a long-distance core network (−up to 1000 km) and also a metro network (−10s km). Dynamic link restoration schemes can be used with the QA system to restore insecure links. For instance if a fibre tapping attack is found between links A and B the end nodes of the insecure link may dynamically discover a route around the link, for each connection (or “live” wavelength) that traverses the link. By employing the QA system for the entire optical link it is also possible to optimize the route wavelength assignment for QKD transmission. Together with a QKD system, the QA technique can provide an optical transport network with multilevel security.

A practical QA system can be simplified by utilizing discrete modulation methods, e.g. binary modulation. In addition, merits of a compact classical transceiver, e.g. a small form-factor pluggable transceiver, can also be exploited for the QA system. Thus there has been described a method for monitoring the physical security of an active optical communications link, by precisely monitoring the channel transmission (e.g. <0.05 dB) and quantum signal excess noise (e.g. <1 snu). This can be used in channel QoS monitoring and in secure optical transport networks.

Some further aspects of the system are defined in the following clauses:

1. A system for monitoring the physical layer security of an optical communications system comprising:
a laser source (112), a quantum transmitter (100) that can modulate and offset a quantum signal (111), a quantum receiver (103);
a high bandwidth classical transmitter (101), a classical receiver (104) and optical time division multiplexer (102);
an optical channel (111) for transmitting both the quantum signals (114) and classical signals (107);
a controller for fault trigger (109) and physical layer security monitoring (105).
2. The system of clause 1 wherein the quantum signal (114) is modified in intensity to be indistinguishable with classical signal.
3. The system of clause 1, wherein said classical signal (107) has much higher bandwidth than quantum signal.
4. The system of clause 1, wherein said the classical signal and quantum signal are time-division-multiplexed, and are sent in random time slots.
5. The method of clause 5, the time-division slot duration is determined by the bandwidth of quantum receiver (103).
6. The method of clause 5, the time division slots are random allocated to quantum signals (114) and classical signals (107).
7. A method for monitoring the physical layer security of the channel comprising the steps to:
determine whether the time slot is allocated to quantum signal
estimate the parameters: the transmittance and excess noise.
monitor the changes in the two parameters, precisely
trigger the alarm if the channel is not safe (the two parameters exceed or below corresponding threshold).
   8. The system or method of any preceding clause, wherein multiple alarm systems can operate in WDM system at multiple wavelength.
   9. The quantum signal can use different modulation protocol, such as Gaussian modulation, m-psk, four state, and so forth.
   10. The system or method of any preceding clause, the quantum signal can be offset to classical level. The offset can also be used to transmit classical data. The security of the classical data in the offset can also be monitored by the invention.
   11. The system or method of any preceding clause, the system can be utilized for the integration of quantum key distribution and classical communication.
   12. The system where the classical and quantum channel use the same transmitter and receiver equipment and are multiplexed using any known multiplexing techniques.
   13. The alarm system where the quantum signal is also used to carry keys as well as monitor.
   14. A system where the classical encryption channel is used to control the monitoring quantum channel or vice versa.
   15. The system or method of any preceding clause, wherein optical link uses optical amplifiers to extend the transmission range of both classical and quantum signals.

No doubt many other effective alternatives will occur to the skilled person. It will be understood that the invention is not limited to the described embodiments and encompasses modifications apparent to those skilled in the art lying within the spirit and scope of the claims appended hereto.

1-22. (canceled)

23. A method of detecting eavesdropping on an optical communications channel, the method comprising:
sending a first, classical message over an optical channel by encoding the message onto an optical carrier using a classical communications technique;
sending a second signal over the optical channel using a quantum cryptographic technique; and
detecting eavesdropping of the classical message on the optical channel by detecting the eavesdropping of the second signal.

24. A method as claimed in claim 23 wherein sending the second signal over the optical channel using a quantum cryptographic technique comprises sending the second signal using a continuous variable quantum key distribution (CV-QKD) technique.

25. A method as claimed in claim 23 wherein the classical message and the second signal are sent at the same wavelength.

26. A method as claimed in claim 23, further comprising interleaving time slots for the classical message and second signal on the optical channel.

27. A method as claimed in claim 26 wherein the interleaving is random.

28. A method as claimed in claim 26 further comprising distinguishing between the time slots for the classical messages and second signal at a receiver and detecting eavesdropping by processing the second signal.

29. A method as claimed in claim 28 wherein the distinguishing comprises attempting decoding of data carried in the time slots of a time-division multiplexed optical signal, delaying the a time-division multiplexed optical signal to compensate for the decoding, and identifying a second signal in the delayed messages by an inability to decode data from a time slot.

30. A method as claimed in claim 23 further comprising matching an optical power of the second signal and classical message on the optical channel.

31. A method as claimed in claim 23 wherein sending the second signal comprises accounting for noise in sending and receiving the second signal, the noise including quantum vacuum noise, and detecting eavesdropping from an additional, unaccounted for noise component when receiving the second signal.

32. A method as claimed in claim 31 wherein accounting for noise in sending and receiving the second signal comprises obtaining a transmitted message noise variance from a transmitter of the second signal, measuring or estimating a noise variance at a receiver of the second signal, the receiver including an optical detector, obtaining a noise value for the detector; and summing the transmitted message noise variance, the noise variance at the receiver, the noise value for the detector, and the quantum vacuum noise to determine an expected total noise; and detecting eavesdropping when a noise value of the second signal is greater than the expected total noise.

33. A method as claimed in claim 23 further comprising using one or more amplifiers in the optical channel and accounting for noise of the one or more amplifiers when detecting eavesdropping of the second signal.

34. A method of transmitting an eavesdropping-protected signal over an optical communications channel, comprising:
sending, time-domain multiplexed over the same optical channel and at the same wavelength, a classical message using a classical communications technique and a second signal using a quantum cryptographic technique.

35. A method as claimed in claim 34 further comprising randomly allocating second signals to time slots of the time-domain multiplexing.

36. A method as claimed in claim 23 further comprising:
receiving, over the same optical channel and at the same wavelength, the first, classical message and the second signal.

37. A system for detecting eavesdropping on an optical communications channel, the system comprising:
a transmitter configured to send over the same optical channel and at the same wavelength, a classical message using a classical communications technique a second signal using a quantum cryptographic technique; and
a receiver configured to receive the classical message and the second signal, and to detect eavesdropping of the classical message on the optical channel by detecting the eavesdropping of the second signal.

38. A method for detecting an eavesdropper on an optical communication channel, the method comprising:
sending a first signal using a classical communication technique and a second signal using a quantum cryptographic technique, over the optical communication channel;
obtaining noise of the second signal and transmittance for the second signal; and
detecting an eavesdropper on the first signal if one or both of the noise and the transmittance of the second signal change by greater than a threshold value.

39. A method as claimed in claim 38 wherein the first signal and the second signal are sent using a time division multiplexing technique.

40. A method as claimed in claim 38 wherein the first signal and the second signal are sent in random time slots.

41. A method as claimed in claim 38 wherein the first signal and the second signal are equal in intensity.

42. A method as claimed in claim 23 wherein the second signal carries classical information.
